(19) United States
(12) Patent Application Publication
(10) Pub. No.: US 2025/0102825 A1
(43) Pub. Date: Mar. 27, 2025

(54) MOBILE HOLOGRAPHIC DISPLAY SYSTEM

(71) Applicant: Robert Clements, Kent, OH (US)

(72) Inventor: Robert Clements, Kent, OH (US)

(21) Appl. No.: 18/832,777

(22) PCT Filed: Jan. 27, 2023
(86) PCT No.: PCT/US2023/011703

§ 371 Date: Jul. 24, 2024

Related U.S. Application Data
(60) Provisional application No. 63/303,579, filed on Jan. 27, 2022.

(51) Int. Cl. G02B 30/54; G02B 30/56

(52) U.S. Cl. CPC G02B 30/54; G02B 30/56

(57) ABSTRACT

A system for displaying a hologram includes a display assembly with a display device, and a motor coupled with the display assembly via a rotating anchor, the motor driving rotation of the display assembly and the display device from a first position to a plurality of positions around a complete rotation of the display assembly and the display device, the display device having a first display when in the first position and different displays when in the plurality of positions, such that the complete rotation of the display device causes the first display and the different displays to form the hologram.

### CROSS-REFERENCE TO RELATED APPLICATIONS

This application claims the benefit of U.S. Provisional Application No. 63/303,579, filed on Jan. 27, 2022, which is incorporated herein by reference.

### FIELD OF THE INVENTION

One or more embodiments of the present invention relate to a system for displaying a hologram. Other embodiments relate to corresponding methods. The system generally includes the combined use of a hardware assembly, which rotates a display device, and software on the display device, for displaying the hologram on the display device. More particularly, a display (e.g., image, video, pixels) of the display device is transformed at various intervals of rotation of the display device, such that an overall rotation of the display device causes the hologram to be displayed as a combination of the displays during rotation.

### BACKGROUND OF THE INVENTION

Mobile phones, tablets, laptop and desktop computers, and other electronic devices have become foundational devices in the everyday lives of consumers. Augmented Reality (AR) development and implementation have allowed developers to create immersive and interactive environments. However, both general electronics usage and AR software are dependent on 2D screen technology and camera control to create these environments, thus creating difficulty for developers and frustration for consumers.

Virtual Reality (VR) and AR goggles or headset systems have been created to further improve the electronic experience. However, many issues have arisen for developers of VR and AR systems, such as difficulty of programming, heavy CPU usage, and difficulty of manufacture. The use of AR and VR systems may also have negative consequences for consumers. For example, some users of VR and AR equipment experience eye strain, headaches, migraines, nausea, and discomfort when using such equipment.

With the increase in AR software sophistication and user desire to enjoy augmented environments, a functional improvement of AR projection and its associated experience is necessary to further improve the growth of enhanced reality systems. There is a need in the art to develop a method of displaying holographic images utilizing everyday electronic devices without the need for additional googles or headset systems.

### SUMMARY OF THE INVENTION

A first embodiment of the present invention provides a system for displaying a hologram, the system including a display assembly including a display device; and a motor coupled with the display assembly via a rotating anchor, the motor driving rotation of the display assembly and the display device from a first position to a plurality of positions around a complete rotation of the display assembly and the display device; the display device having a first display when in the first position and different displays when in the plurality of positions, such that the complete rotation of the display device causes the first display and the different displays to form the hologram.

A second embodiment of the present invention provides a system as in any of the above embodiments, further comprising a base assembly supporting the display assembly, wherein the motor is housed within the base assembly.

A third embodiment of the present invention provides a system as in any of the above embodiments, further comprising a base assembly supporting the display assembly, wherein the motor is positioned separate from the base assembly.

A fourth embodiment of the present invention provides a system as in any of the above embodiments, wherein the rotating anchor is a rotating shaft.

A fifth embodiment of the present invention provides a system as in any of the above embodiments, wherein the display device is a smartphone, a tablet, a television, a laptop computer, or a desktop computer.

A sixth embodiment of the present invention provides a system as in any of the above embodiments, wherein the display device is a smartphone.

A seventh embodiment of the present invention provides a system as in any of the above embodiments, wherein the base assembly includes a metal baseplate having the rotating anchor passing therethrough.

An eighth embodiment of the present invention provides a system as in any of the above embodiments, one end of the metal baseplate being fastened to a first frame section of the base assembly, and another end of the metal baseplate being fastened to a second frame section of the base assembly.

A ninth embodiment of the present invention provides a system as in any of the above embodiments, the motor being positioned underneath the baseplate and between the first frame section and the second frame section.

A tenth embodiment of the present invention provides a system as in any of the above embodiments, wherein the hologram is a real-time rendering of an image or scene.

An eleventh embodiment of the present invention provides a system as in any of the above embodiments, wherein the hologram is a pre-rendered image or scene.

A twelfth embodiment of the present invention provides a system as in any of the above embodiments, wherein the hologram is viewable without 3D glasses.

A thirteenth embodiment of the present invention provides a system as in any of the above embodiments, wherein the display device is permanently positioned within the display assembly.

A fourteenth embodiment of the present invention provides a system as in any of the above embodiments, wherein the display device is a first display device which is interchangeable with a second display device for positioning within the display assembly.

A fifteenth embodiment of the present invention provides a method of displaying a hologram, the method including steps of selecting an image or video to be displayed as the hologram; providing a display device secured with a rotatable device holder, the display device containing software to create a three-dimensional rendering of the image or video to be displayed as the hologram; creating, via the software on the display device, the three-dimensional rendering of the image or video to be displayed as the hologram; rotating the display device and the rotatable device holder while the display device is displaying the three-dimensional rendering of the image or video to be displayed as the hologram, such that the step of rotating reveals the hologram via the three-dimensional rendering of the image or video to be displayed as the hologram.

A sixteenth embodiment of the present invention provides a method as in any of the above embodiments, wherein the step of rotating the display device and the rotatable device holder is performed by a motor, the motor being within a base assembly which base assembly is securing the rotatable device holder.

A seventeenth embodiment of the present invention provides a method as in any of the above embodiments, further comprising a step of calibrating a speed of the step of rotating.

An eighteenth embodiment of the present invention provides a method as in any of the above embodiments, further comprising a step of calibrating a frame rate of the three-dimensional rendering of the image or video to be displayed as the hologram during the step of rotating.

A nineteenth embodiment of the present invention provides a method as in any of the above embodiments, wherein the display device is a smartphone, a tablet, a television, a laptop computer, or a desktop computer.

### BRIEF DESCRIPTION OF THE DRAWINGS

Embodiments of this invention will now be described by way of example only in association with the accompanying drawings in which:

FIG. 1 shows a perspective view of a system for displaying a hologram, shown without a display device;

FIG. 2 shows a top view of the system of FIG. 1;

FIG. 3 shows a front view of a system for displaying a hologram, shown with a display device;

FIG. 4 shows a schematic of two different display points of the display device, relative to displaying different viewpoints to a left eye and a right eye for creating a stereoscopic image;

FIG. 5 shows a photo of a view-independent hologram displayed on a display device;

FIG. 6 shows a schematic of rotation of a virtual camera around an object or scene for creating a view independent hologram;

FIG. 7 shows a schematic of rotation of the virtual camera around an object or scene for creating a view dependent hologram;

FIG. 8 shows a schematic including method steps for a software for a view independent hologram;

FIG. 9 shows a schematic including method steps for a software for a view dependent hologram;

FIG. 10 shows a schematic including method steps for operating a system for displaying a hologram;

FIG. 11 shows a photo of a view-dependent hologram displayed on a display device;

FIG. 12 shows a perspective view of an alternative system for displaying a hologram; and

FIG. 13 shows a variable speed adjustment coupled with a base assembly.

### DETAILED DESCRIPTION OF ILLUSTRATIVE EMBODIMENTS

One or more embodiments of the present invention relate to a system for displaying a hologram on a display device (e.g., cell phone). Other embodiments relate to corresponding methods of operating the system. The system generally includes the combined use of a hardware assembly, which rotates the display device at an adjustable rate of speed, and software on the display device for displaying the hologram on the display device. As the display device is rotated, the software transforms a display (e.g., image, video, pixels) of the display device at various intervals of rotation of the display device. In this way, a combination of the transformed displays serves to form the hologram, which hologram will be displayed on the display device. Said another way, an overall rotation (e.g., 360° rotation) of the display device causes the hologram to be displayed as the combination of image slices on the device during rotation. Black or darker pixels appear transparent as the display rotates allowing the user to freely view the volume from any orientation. One or more embodiments of the present invention relate to a method of adjustably rotating the display device while adjusting the software rendering and hardware spinning speed to match the correct orientation for displaying the hologram during the overall rotation of the display device.

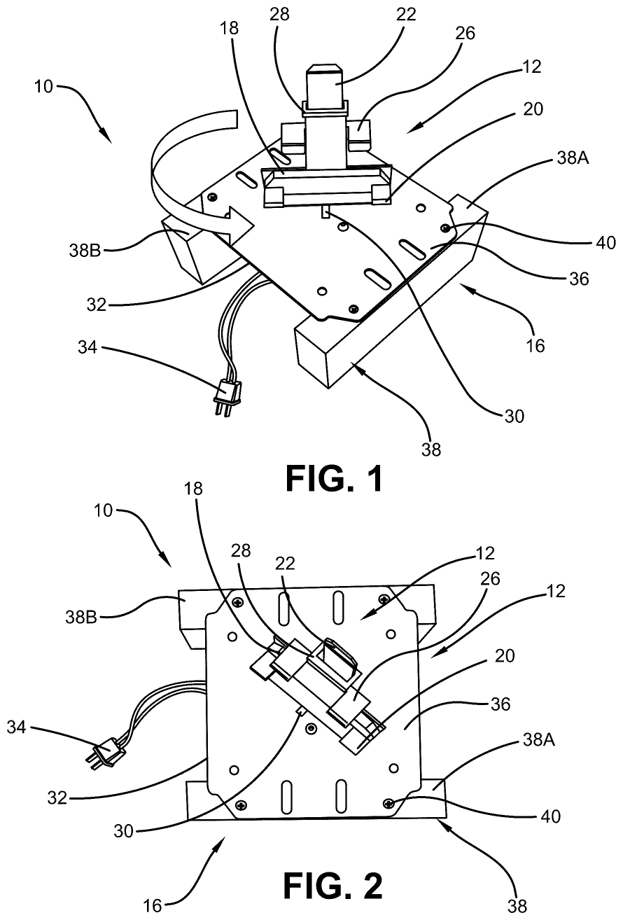

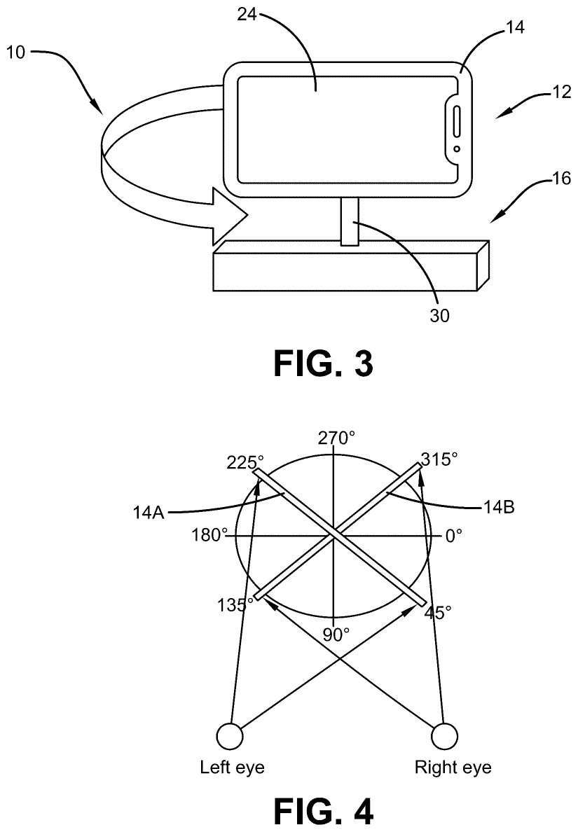

With reference to the Figures, particularly FIGS. 1 to 3, a system for displaying a hologram on a display device is generally indicated by the numeral 10. System 10 includes a display assembly 12, which generally serves to securely hold a display device 14 (FIG. 3) in place for rotation thereof. Display assembly 12 can be supported by a base assembly 16. Display assembly 12 can be coupled with the base assembly 16 in order to provide the support. Base assembly 16 generally serves to securely hold the display assembly 12 in place. In one or more embodiments, display device 14 of display assembly 12 does not communicate with base assembly 16. In other embodiments, display device 14 of display assembly 12 can communicate with base assembly 16, such as via Bluetooth® communication.

As mentioned above, display assembly 12, which may also be referred to as rotatable device holder 12, securely holds display device 14 in place for rotation of display device 14 via rotation of display assembly 12. Any suitable structure achieving this function may be utilized. In one or more embodiments, display assembly 12 can include a protective case for the display device 14.

In one or more embodiments, the display assembly 12 has an integral display device 14, which may also be referred to as a fixed display device 14 or permanent display device 14. That is, a user would generally not interchange the display device 14 between each use. The display device 14 would be relatively permanently positioned within system 10. This is generally shown in FIG. 3. Another exemplary structure for a fixed position display device 14 would be a frame utilizing screws to secure display device 14.

In other embodiments, the display assembly 12 has a structure for receiving an interchangeable display device, which may also be referred to as a non-fixed display device or temporary display device. That is, a user would add a first display device prior to use, and then remove the first display device following the use. Then, a second user would add a second display device prior to use, and then remove the second display device following the use. This is generally shown in FIGS. 1 and 2, though without the display devices.

As shown in FIGS. 1 to 3, an exemplary display assembly 12 includes a bottom frame 18 against which a bottom of display device 14 can be placed. Display assembly 12 can include edge frames 20 at each end of bottom frame 18. Edge frames 20 can be spaced according to the width of a predetermined size of display device 14. That is, sides of display device 14 may abut edge frames 20 for assistance with securing display device 14 in display assembly 12.

Display assembly 12 can include a backing support 22 against which a back of display device 14 can be placed. That is, a screen 24 (FIG. 3) of display device 14 should face away from backing support 22, such that a user can view the entirety of screen 24, or substantial portion thereof, when system 10 is in use.

Display assembly 12 can include a top frame 26 against which a top of display device 14 can be placed. Top frame 26 may include respective sub-components on each side of backing support 22. Top frame 26 may be coupled with an adjustment sleeve 28 which is sized to fit over backing support 22. In this way, top frame 26 and adjustment sleeve 28 can travel upward and downward to account for different sizes of display device 14. Though not shown in the Figs., top frame 26 and adjustment sleeve 28 can include a locking mechanism for fixedly positioning display device 14 within a given position. Such locking mechanism, or other suitable locking structure (e.g., strap), should securely maintain display device 14 within display assembly 12 in a way where display device 14 is maintained within display assembly 12 upon rotation.

Further details of the display device 14 are now provided. Display device 14 can be any suitable device having a display screen 24 and being capable of being rotated at suitable speeds. Exemplary specific devices for the display device 14 include smartphones, tablets, televisions, laptop computers, and desktop computers. Display device 14 may include a gyroscope.

Display device 14 should include a suitable screen refresh rate in order to sufficiently change the display during the rotation thereof. The screen refresh rate of display device 14 can be relatively high or relatively slow depending on the desired hologram to be displayed.

In conjunction with the screen refresh rate, display device 14 may be characterized by the number of different displays shown within one 360° rotation. The number of different displays shown within one 360° rotation of display device can be one display and up to as many as the display device 14 can update the screen. This may be about 144 hz for a high refresh rate screen, or in other embodiments greater than 144 hz, or lower than 144 hz, or any suitable rate therein. Again, suitable screen refresh rate can be dependent screen technology, so future higher refresh rates (e.g., up to 600 hz) are also envisioned as being suitable.

As mentioned above, display assembly 12 can be coupled with base assembly 16, which may also be referred to as frame 16. As shown in FIGS. 1 to 4, display assembly 12 is shown with an anchor 30 extending from the bottom thereof, which anchor 30 couples display assembly 12 with base assembly 16. Anchor 30 may be referred to as a rotating anchor 30, and as shown in FIGS. 1 to 3, an exemplary rotating anchor 30 is a rotating shaft 30. Rotating shaft 30 is particularly coupled with bottom frame 18 to thereby couple bottom frame 18 with a motor 32.

Rotating shaft 30 thereby serves to couple display assembly 12 with motor 32. Motor 32 can include a power cord 34 (e.g., AC, USB) coupled therewith, or another form of power source (e.g., battery). Though not shown in the Figs., motor 32 can also include one or more of a variable motor speed adjuster and an automatic motor speed adjuster. The one or more motor speed adjusters can be utilized to adjust the speed at which motor 32 rotates display assembly 12. The one or more motor speed adjusters can be utilized in conjunction with the suitable software on display device 14.

Rotating shaft 30 can extend downward through a baseplate 36, which position of rotating shaft 30 may be in a center, or near the center, of baseplate 36. In this way, motor 32 can be below baseplate 36 such that baseplate 36 can generally serve to provide a protective housing for motor 32. In other embodiments, motor 32 may be positioned away from base assembly 16. For example, a belt (not shown) may be utilized to drive the shaft. Any suitable rotation can be utilized and should support the rotation and weight.

The coupling of rotating shaft 30 within baseplate 36 should allow for rotation thereof and should suitably avoid excessive friction. This can include the use of a bearing sleeve (not shown) or other suitable component allowing for rotation of rotating shaft 30 while generally being supported by baseplate 36 and therefore by base assembly 16. There may or may not be a component between the shaft 30 and baseplate 36, so long as smooth rotation is achieved.

With specific reference to FIG. 12, an alternative rotating shaft 30B is shown. Rotating shaft 30B is wider than rotating shaft 30, and includes a plastic or rubber protective sheath. Alternative rotating shaft 30B is shown such that it should be appreciated any suitable structure for facilitating smooth rotation of display device 14 can be utilized.

As shown in FIGS. 1 to 3, baseplate 36 can also serve to connect different portions of an overall frame 38. That is, one end of baseplate 36 may be fastened, with one or more fasteners 40, to a first frame section 38A and another end of baseplate 36 may be fastened to a second frame section 38B. In other embodiments, overall frame 38 is a unitary construct, such as a square shape.

Baseplate 36 and overall frame 38 together may be referred to as a motor housing. In other embodiments, baseplate 36 and overall frame 38 may be a unitary construct. Baseplate 36 may be made of metal, or other suitable material such as plastic. Overall frame 38 may be made of wood, or other suitable material such as plastic or metal.

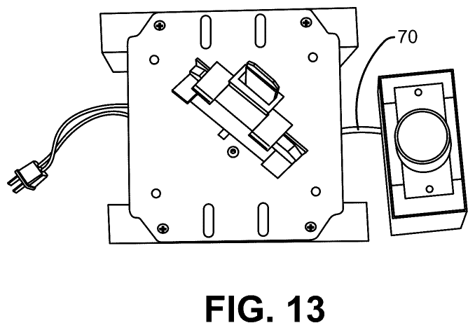

As shown in FIG. 13, a variable speed adjustment assembly 70 may be coupled with base assembly 16. Variable speed adjustment assembly 70 may include a knob or dial for adjusting the rotation speed. Other techniques for controlling rotation speed are also envisioned, such as controlling the properties of motor 32.

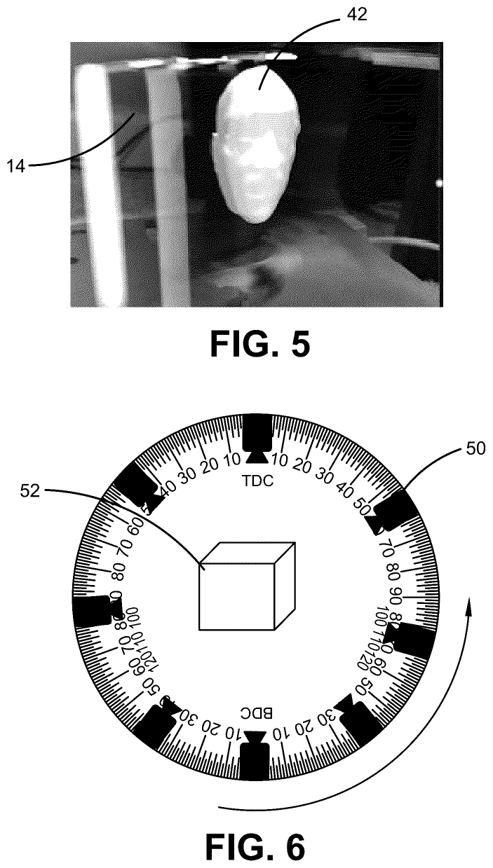

Whether system 10 is utilized, or another form of suitable hardware, the hardware should be suitable for rapidly rotating display device 14. As the screen 24 of the display device 14 rotates at an adjustable rate of speed, bright pixels will be made visible within the correct position in space whereas black pixels, and/or dim pixels, are more transparent to the viewer. This combination of pixels across the various rotational positions will create the volumetric hologram 42 (FIG. 5) that exists as voxels within the rotational area, which may also be referred to as a floating three-dimensional display 42. As will be further discussed herein, the hardware rotation speed should suitably correspond with the software rendering, and any adjustments thereof, in order to match the correct orientation (i.e., plane orientation) during the rotation of display device 14.

The system 10 or other suitable hardware may be characterized by rotation speed provided to display device. As mentioned herein, the rotation speed can be relatively high or relatively low, and the rotation speed can be adjustable. The rotation speed should be adjusted, which can be automatically or manually, to a desired or optimal rate for any given screen or type of hologram being generated.

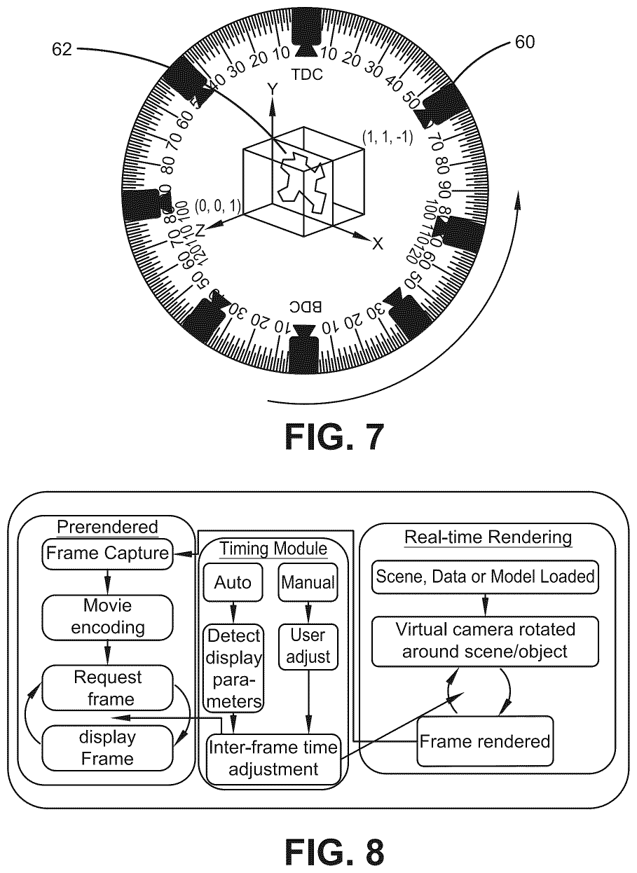

As suggested above, embodiments of the present invention include suitable software for displaying the hologram on the display device. This software can exist as a website, video, still image, or downloadable application using the outlined framework. The software should be developed according to the methods and details disclosed herein, and should be downloaded or downloadable to the display device 14. The software will generally serve to regulate the speed of rotation of the digital scene, the frame rate of the image or scene displayed, as well as the virtual plane within the scene rendered. The software should allow for suitable rastering as the device 14 rotates. Other functions of suitable software may include one or more of drawing a cross-section plane of a scene or object on the display device with a black (or darker) background and rotating the scene or object on the display device at a set frequency. For more complex holograms, as long as the software can adjust the speed of rotation and the frame (rate), or virtual slice of the image or scene displayed, then the software can work in the present invention. Other holograms may include display of a static image, which may require less robust software. The software can include a virtual camera being rotated around the image or scene (FIGS. 6 and 7) or the image or scene being rotated about a fixed virtual camera (not shown) or a rotating cross-section of the scene.

The system 10 and software can create either a view independent hologram or a view dependent hologram. The steps of the software will depend on whether a view independent hologram or a view dependent hologram is being created. A view independent hologram means each position of a viewer will lead to seeing the same hologram view, and in this case, the image of the object or scene should be rotated on the screen 24 of the display device 14 itself. That is, the hologram itself is rotated while the display device 14 is rotated. A view dependent hologram means different positions of a viewer will lead to seeing different hologram views. In this case, a slice of the scene or image is shown by the display device 14, and the position of the slice is shifted (if required by the generated image) during rotation of the display device 14.

As mentioned above, in the case of a view independent hologram, if there are multiple users surrounding the display device 14 within the system 10, then each user would see the same viewpoint regardless of their viewing position around the device 14. A view of an entire scene or object should be pre-rendered as the virtual camera is rotated around the scene and the timing of frames displayed is adjusted automatically. Or the timing can be adjusted manually with user input if that level of interaction is desired.

Aspects of software for a view independent hologram are now disclosed. If the image or scene to be displayed is a real-time rendering of an image or scene, then the image or scene can be loaded into the software, which may also be referred to as a program, a virtual camera 50 (FIG. 6) can be rotated around the image or scene 52 or the image or scene is rotated about a fixed virtual camera, and then a timing module can be used to make sure the image or scene is displayed to the display device 14 at the correct position and refresh rate in three-dimensional space as the display device 14 is rotated. The timing module can be done automatically by the software or manually adjusted on the hardware by the user. In this event, the software would detect the parameters of the display device 14 and then make inter-frame time adjustment to finally render the image or scene 52. If the timing module is done by the user, then the user would make the necessary adjustments manually and then the frame would be rendered.

If a view independent hologram is desired and the image or scene to be displayed is a pre-rendered image or scene, then the frame is captured, the image or scene is encoded, the frame is requested, then a timing module is used in the same manner as for real time rendering for a view independent hologram, and then the image or scene is displayed.

As the display device 14 rotates within system 10 at an adjustable rate of speed, the image or scene 52 is timed to display a different frame of the rotating scene offset by the interframe time adjustment during the time module. The interframe time adjustment offsets the rendered frames by set degrees (or if done manually, then by user specific degrees) to direct a different viewpoint 14A (FIG. 4) to the left eye and a different viewpoint 14B to the right eye of the users to create a stereoscopic image or scene viewable from all angles around the screen. Frame blanking may also be used to reduce interocular crosstalk as necessary. FIG. 6 shows a schematic of the rotation of the virtual camera 50 around the object or scene 52 for a view independent hologram. Further details of suitable method steps are also shown in FIG. 8.

For a system and method in accord with the above discussion, FIG. 5 shows a photo of a view-independent hologram.

As mentioned above, in the case of a view dependent hologram, if there are multiple users surrounding the display device 14 within the system 10, then each user would see a different viewpoint of the scene or object depending on their position around the display. Orthographic cross-sectional planes rotating through a scene or object are sequentially rendered, and when the display device 14 rotates, a cross-sectional plane is displayed at the correct orientation within the 360-degree rotational cylinder. The displayed frame can be adjusted using input from the gyroscope within the display device, or can be adjusted based on timing adjustment controlled by either the user (utilizing the hardware and/or software) or by the software. That is, for a gyroscopic based technique, as the device 14 rotates, the gyroscopic data from device 14 can be used to adjust the drawn slice through the scene. And for a timing-based technique, as the device 14 rotates, the scene can be rendered as a small sliver that is rotated around the central axis, and software or hardware tuning can be used to match frequency so the frame is displayed in the corresponding position in the rotated display.

Aspects of software for a view dependent hologram are now disclosed. If the image or scene to be displayed is a real-time rendering of an image or scene, then the image or scene is loaded into the program, a cross-sectional virtual camera frustrum is set, a virtual camera 60 (FIG. 7) is rotated around the image or scene 62 or the image or scene is rotated about a fixed virtual camera, and then a timing module is used to make sure the image or scene is displayed to the display device at the correct position in three-dimensional space as the display device is rotated. The timing module can be done automatically by the software and/or adjusted by the user. If by the software, the software can detect the parameters of the display device and would take sensor polling of the display device, and then make inter-frame time adjustment to finally render the image or scene. If the timing module is done by the user, then the user would make the necessary adjustments manually and then the frame would be rendered.

If a view dependent hologram is desired and the image or scene to be displayed is a pre-rendered image or scene, then the frame is captured, the image or scene then the frame is captured, the image or scene is encoded, the frame is requested, then a timing module is used in the same manner as for real time rendering for a view dependent hologram, and then the image or scene is displayed.

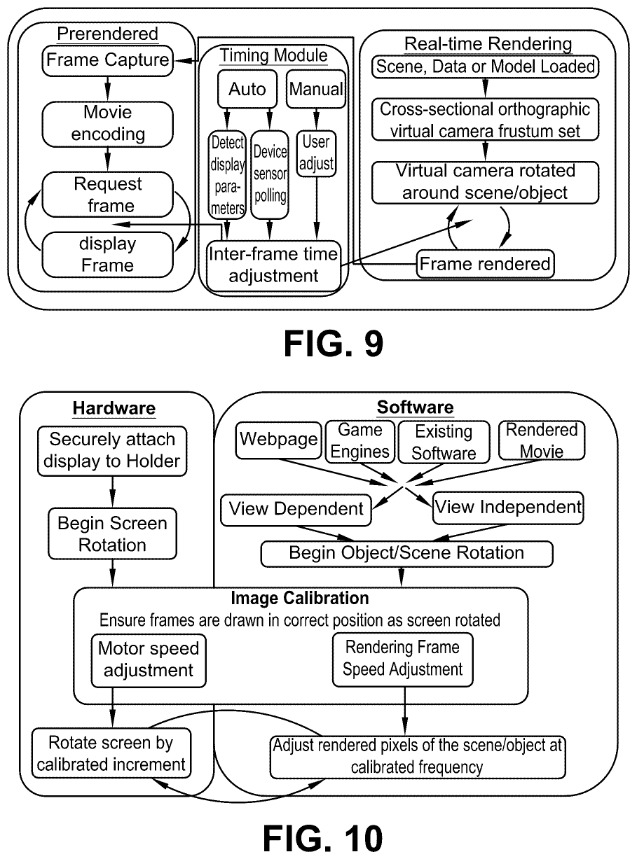

As the display device 14 rotates within system 10 at an adjustable rate of speed, a cross-section 62 of the image or video is timed to display a different plane in the various respective positions in physical space. As each plane around 360 degrees is displayed, only non-black (or non-dim) pixels are visible at the respective position in space. The rotation speed of the display device allows the pixels within the planes in space to be perceivable as voxels in the display volume. This creates a floating three-dimensional holographic spatial object that can be viewed from different perspectives around the display device. FIG. 7 shows a schematic of the rotation of the virtual camera 60 around the object or scene 62 (i.e., orthographic cross-sections thereof) for a view dependent hologram. Further details of suitable method steps are also shown in FIG. 9.

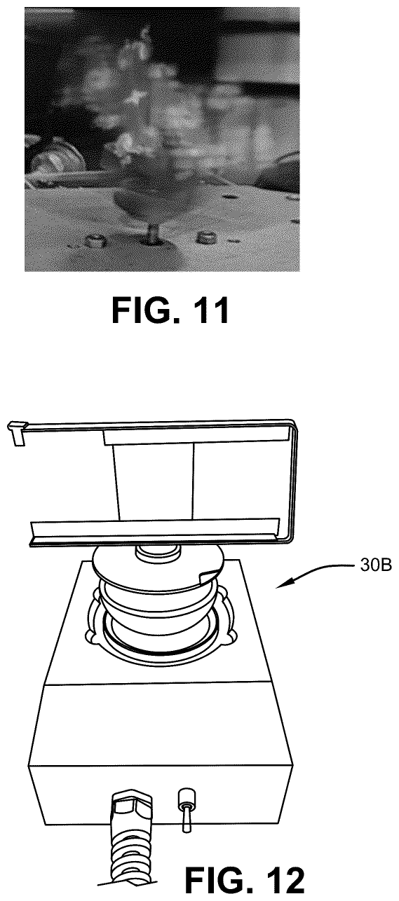

For a system and method utilizing the above discussion, FIG. 11 shows a photo of a view-dependent hologram.

Where a software technique is gyroscopic based, the software can rely on a gyroscopic sensor of the device 14. These display devices 14 commonly include a gyroscopic sensor and when these devices rotate, input from the gyroscopic sensor is captured. The angle of rotation captured from the gyroscopic sensor can be used to set the position of the rendered virtual plane. Then, the virtual plane image orientation can be matched to the rotation orientation of the display device 14 of system 10. As the display device 14 is spun at a high speed, bright pixels are visible within the correct position in space, thereby creating a floating three-dimensional object within the display's rotational volume.

While aspects of a method of operation are discussed above, other details are included here. As discussed above, one or more embodiments of the present invention includes a method of creating a holographic display. First, the user can select an image or video to be displayed as a three-dimensional hologram. Then, a display device 14 can be securely attached to the rotatable device holder 12 of system 10. Once the display device 14 is in place, an image or video can be selected, and software downloaded to the display device will take the selected image or video to create a three-dimensional rendering of the selected image or video. Once the software determines whether the three-dimensional rendering is view dependent or view independent, the various steps discussed above for each type of hologram can be undertaken. Then rotation of the display device 14 can begin while the software begins to create the three-dimensional rendering. Once the process begins, image calibration may need to take place by adjusting the speed of the motor 32 within the system 10. Calibration of the frame rate by the software on the display device 14 may also occur, which can be done either by the user manually or by the software. Finally, the display device 14 would be ready to display the three-dimensional hologram 42 thereon by rotation at a now calibrated increment, with the rendered pixels being displayed at a now calibrated frequency to produce the holographic display 42.

These and other aspects of a method of operation are shown in FIG. 10.

While advantages and applications of embodiments of the present invention are discussed above, other details are included here. One or more embodiments of the present invention provide a glasses free 3D projection of holographic content. One or more embodiments of the present invention provide stereoscopic and/or passive images. One or more embodiments of the present invention can be used with one or more of video games, augmented reality, metaverse, advertising, and medical imaging.

In light of the foregoing, it should be appreciated the present invention advances the art by providing an improved system for displaying a hologram and corresponding methods, while utilizing inexpensive and widely available hardware. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

1. A system for displaying a hologram, the system comprising
a display assembly including a display device; and
a motor coupled with the display assembly via a rotating anchor, the motor driving rotation of the display assembly and the display device from a first position to a plurality of positions around a complete rotation of the display assembly and the display device;
the display device having a first display when in the first position and different displays when in the plurality of positions, such that the complete rotation of the display device causes the first display and the different displays to form the hologram.

2. The system of claim 1, further comprising a base assembly supporting the display assembly, wherein the motor is housed within the base assembly.

3. The system of claim 1, further comprising a base assembly supporting the display assembly, wherein the motor is positioned separate from the base assembly.

4. The system of claim 1, wherein the rotating anchor is a rotating shaft.

5. The system of claim 1, wherein the display device is a smartphone, a tablet, a television, a laptop computer, or a desktop computer.

6. The system of claim 1, wherein the display device is a smartphone.

7. The system of claim 1, wherein the base assembly includes a metal baseplate having the rotating anchor passing therethrough.

8. The system of claim 7, one end of the metal baseplate being fastened to a first frame section of the base assembly, and another end of the metal baseplate being fastened to a second frame section of the base assembly.

9. The system of claim 8, the motor being positioned underneath the baseplate and between the first frame section and the second frame section.

10. The system of claim 1, wherein the hologram is a real-time rendering of an image or scene.

11. The system of claim 1, wherein the hologram is a pre-rendered image or scene.

12. The system of claim 1, wherein the hologram is viewable without 3D glasses.

13. The system of claim 1, wherein the display device is permanently positioned within the display assembly.

14. The system of claim 1, wherein the display device is a first display device which is interchangeable with a second display device for positioning within the display assembly.

15. A method of displaying a hologram, the method comprising steps of selecting an image or video to be displayed as the hologram;
providing a display device secured with a rotatable device holder, the display device
containing software to create a three-dimensional rendering of the image or video to be displayed as the hologram;
creating, via the software on the display device, the three-dimensional rendering of the image or video to be displayed as the hologram;
rotating the display device and the rotatable device holder while the display device is displaying the three-dimensional rendering of the image or video to be displayed as the hologram, such that the step of rotating reveals the hologram via the three-dimensional rendering of the image or video to be displayed as the hologram.

16. The method of claim 15, wherein the step of rotating the display device and the rotatable device holder is performed by a motor, the motor being within a base assembly which base assembly is securing the rotatable device holder.

17. The method of claim 15, further comprising a step of calibrating a speed of the step of rotating.

18. The method of claim 15, further comprising a step of calibrating a frame rate of the three-dimensional rendering of the image or video to be displayed as the hologram during the step of rotating.

19. The method of claim 15, wherein the display device is a smartphone, a tablet, a television, a laptop computer, or a desktop computer.
